(19) United States
(12) Patent Application Publication
(10) Pub. No.: US 2017/0087502 A1
(43) Pub. Date: Mar. 30, 2017

(54) ADSORBENT MEDIA AND SYSTEMS FOR REMOVAL OF MALODOROUS COMPOUNDS FROM A CONTAMINATED GAS AND METHODS OF FABRICATION

(71) Applicant: Pure Air Filtration, LLC, Norcross, GA (US)

(72) Inventors: Kevin F. Jameson, Norcross, GA (US); Jeffrey Gaulding, Norcross, GA (US)

(21) Appl. No.: 15/271,585

(22) Filed: Sep. 21, 2016

Related U.S. Application Data
(60) Provisional application No. 62/232,875, filed on Sep. 25, 2015.

(51) Int. Cl. B01D 53/04; B01J 20/28; B01J 20/10; B01J 20/08; B01D 53/12; B01J 20/20

(52) U.S. Cl. CPC B01D 53/0423; B01D 53/12; B01J 20/20; B01J 20/103; B01J 20/08; B01J 20/28016; B01J 20/28045; B01D 2257/306; B01D 2253/102; B01D 2253/104; B01D 2253/106; B01D 2253/108; B01D 2253/34; B01D 2253/25; B01D 2253/1122; B01D 2253/3425

(57) ABSTRACT

An adsorbent media composition, adsorbent apparatus, and gas purification process using the absorbent media composition are provided for the removal of dimethyl disulfide from a gas containing at least dimethyl disulfide as an impurity. The adsorbent media composition includes a combination of a support material and a removal material capable of removing dimethyl disulfide from the gas. In particular, the support material is used in combination with an iron material as a removal material, wherein the iron material provides for enhanced and efficient removal of dimethyl disulfide from a gas.

### CROSS-REFERENCE TO RELATED APPLICATIONS

This application claims the benefit of U.S. Provisional Patent Application Ser. No. 62/232,875, filed Sep. 25, 2015, entitled “Adsorbent Media and Systems for Removal of Malodorous Compounds From a Contaminated Gas and Methods of Fabrication,” which is incorporated by reference herein in its entirety.

### FIELD OF THE INVENTION

The present invention generally relates to an adsorbent composition and system, and more particularly to an adsorbent composition and system for the removal of one or more malodorous compounds from a contaminated gas. In particular, the present invention relates to an adsorbent composition for the removal of dimethyl disulfide from a gas, the adsorbent composition containing an iron material.

### BACKGROUND

Many industrial activities, such as sewage treatment, waste treatment and disposal, petroleum refining, wood-pulping, natural gas and petrochemical plants, plastic manufacture, food processing, and a variety of chemical industries, emit malodorous compounds into the environment. Such malodorous compounds include methanethiol, dimethyl sulfide, dimethyl disulfide and hydrogen sulfide. These malodorous compounds are considered environmental contaminants and are often subject to regulation because they can cause a variety of undesirable reactions in living organisms and the environment.

Hydrogen sulfide, a colorless gas with the characteristic odor of rotten eggs, is a malodorous compound that is very poisonous, corrosive, flammable, and explosive. Although it is disagreeably odorous at first, it can deaden one's sense of smell by paralyzing the respiratory center of the brain and olfactory nerve and, thus, one may subsequently be unable to detect its presence after initial exposure. Exposure to hydrogen sulfide at heightened levels can cause rapid loss of consciousness and death. Hydrogen sulfide has long been recognized as a major problem for municipal wastewater systems and other industries and, thus, its removal has been considered a priority for some time.

The removal of dimethyl disulfide from contaminated air and gas streams has been less of a focus. However, the presence of dimethyl disulfide is also a problem because it is highly flammable and presents a dangerous fire hazard when exposed to heat, flame, and oxidizers. If inhaled, dimethyl disulfide can cause headaches, nausea, dizziness and drowsiness.

A variety of vapor-phase technologies have been developed to control malodorous compounds in the air and gas streams. For example, physico-chemical based methods have been developed, including absorption or wet scrubbing, adsorption, condensation, ozonation, and photo-catalytic oxidation. The particular method used in a given case is generally determined by the target compound(s) and their composition in the air or gas stream.

Adsorption-based systems are the most commonly used for the removal of malodorous compounds from the air and gas streams. In such systems, the contaminated air or gas stream is brought into contact with a solid adsorbent material that is designed to attract the target compounds. Adsorption can be characterized as either physical adsorption or chemisorption based on how the adsorbent material interacts with the adsorbate. In physical adsorption, the malodorous compounds are physically attracted to and held on the adsorbent material without chemical bonding. Physical adsorption involves weaker forces (e.g. van der Waals), which can allow for the subsequent removal of the adsorbate and regeneration of the adsorbent material for future use. Chemisorption involves a chemical reaction between the surface and the adsorbate, and is typically stronger and irreversible.

While many adsorbent media compositions have been developed targeting the removal of hydrogen sulfide from contaminated air and gas streams, improvements are still needed. It would further be desirable to provide an adsorbent media and system that targets the removal of dimethyl disulfide, which has not been a focus to date. In addition, it would be desirable to provide an adsorbent media and system that targets the removal of a plurality of malodorous compounds. It would further be desirable to provide adsorbent media and systems which are capable of efficiently removing one or more targeted compounds from large quantities of gases.

### SUMMARY OF INVENTION

Aspects of the present invention are directed to an adsorbent media composition for the removal of one or more malodorous compounds from a gas or the air (hereinafter collectively referred to herein as “a gas”) containing at least one impurity, and a method for removing at least one malodorous compound from a gas using the adsorbent media composition. Further provided is an adsorbent system containing the adsorbent media composition for removal of at least one impurity from a gas.

More particularly, the present invention provides an adsorbent media composition and system for the removal of dimethyl disulfide from a gas containing at least dimethyl disulfide as an impurity.

According to one aspect, an absorbent media composition that contains a combination of a support material and an iron material is provided. According to various embodiments, the support material is selected from carbon, alumina activated carbon, activated alumina, zeolites, silica, and mixtures thereof. The adsorbent media compositions provided by the present invention have an enhanced capacity for the adsorption of dimethyl disulfide from a gas containing at least dimethyl disulfide as an impurity.

According to another aspect, an adsorbent media composition is provided for removing dimethyl disulfide from a gas containing at least dimethyl disulfide as an impurity, wherein the adsorbent media composition comprises a support material selected from carbon, alumina, activated carbon, activated alumina, silica, zeolites and combinations thereof, and a removal material combined with the support material. The removal material may be selected from materials that contain iron. The removal material may coat at least a surface of the support material, is impregnated or embedded in the support material, is physically or chemically bonded or adhered to at least one surface of the support material, is dispersed within the support material, or a combination thereof.

According to various embodiments, the adsorbent media composition comprises granules, powders, particles, pellets, cylinders, trochiodal shapes, flakes, beads, rings, irregular shapes, extruded structures, matrices, honeycomb structures, meshes, helixes and combinations thereof. The adsorbent media composition may comprise about 50 wt % to about 99. 9 wt % support material and about 0.1 wt % to about 50 wt % of iron removal material, based on total weight of the adsorbent media composition. According to various embodiments, the iron removal material includes an amount of iron that provides removal of the target malodorous compound. According to some embodiments, the iron removal material comprises at least about 5 wt % iron based on total weight of the removal material.

According to another embodiment, an adsorbent media composition is provided for removing dimethyl disulfide from a gas containing at least dimethyl disulfide as an impurity, wherein the adsorbent media composition comprises a surface modified support material. The support material is selected from carbon, alumina, activated carbon, activated alumina, silica, zeolites and combinations thereof, and the support material is surface modified by a removal material comprising iron.

According to various embodiments, the composition comprises about 50 wt % to about 99. 9 wt % support material and about 0.1 wt % to about 50 wt % of iron removal material, based on total weight of the adsorbent media composition. According to various embodiments, the removal material includes an amount of iron that provides removal of the target malodorous compound. According to some embodiments, the iron removal material comprises at least about 5 wt % iron based on total weight of the iron removal material.

According to another embodiment, an apparatus for removal of dimethyl disulfide from a gas containing at least dimethyl disulfide as an impurity is provided. The apparatus comprises a reactive chamber having an interior volume, an inlet and outlet, and a gas flow path within the interior volume extending between the inlet and outlet, and an adsorbent media composition dispersed within the interior volume in the gas flow path, the adsorbent media composition comprising a support material and an iron based removal material.

According to various embodiments, the reactive chamber is in the form of a packed column, plate column, spray chamber, spray tower, or cyclonic spray chamber.

According to another embodiment, method for removal of dimethyl disulfide from a gas containing at least dimethyl disulfide as an impurity is provided. The method comprises providing an adsorbent media composition comprising a support material and an iron based removal material, contacting the gas with the adsorbent media composition, and allowing the adsorbent media composition to remove at least a portion of dimethyl disulfide from the gas via adsorption.

According to various embodiments, the step of contacting the gas with the adsorbent media composition comprises passing the gas through a reaction chamber containing the adsorbent media therein. According to various embodiments, the reaction chamber is in the form of a packed column, plate column, spray chamber, spray tower, or cyclonic spray chamber.

Other aspects, embodiments and advantages of the present invention will become readily apparent to those skilled in the art are discussed below. As will be realized, the present invention is capable of other and different embodiments without departing from the present invention. Thus the following description as well as any drawings appended hereto shall be regarded as being illustrative in nature and not restrictive.

### DETAILED DESCRIPTION OF THE INVENTION

According to the present invention, an adsorbent media composition is provided for the removal of one or more malodorous compounds from a gas. For example, the adsorbent media composition can suitably be used for the removal of one or more malodorous compounds from various process streams including, but not limited to, landfill gas, digester gas, and wastewater treatment gas. The novel adsorbent media composition, adsorbent system, and method described herein are particularly useful for the removal of dimethyl disulfide from a contaminated gas.

As referred to herein, “removal” of one or more malodorous compounds (e.g., dimethyl disulfide) from a gas refers to any extent of removal such that the gas prior to contact with the present adsorbent media contains a greater level of the one or more malodorous compounds than the gas after contact with the present adsorbent media. Thus, removal is not limited to complete and total elimination of the one or more malodorous compounds. It is, however, preferred that the extent of removal is at least about 50% removal of the target compound(s), more preferably at least about 60%, at least about 65%, at least about 70%, at least about 75%, at least about 80%, at least about 85%, at least about 90%, and even amounts of at least about 95%.

In addition, as referred to herein, “enhanced” removal of dimethyl disulfide from a gas relates to the ability of the present adsorbent media to remove dimethyl disulfide from a gas, where the enhanced removal results from providing the iron material on the support material. In other words, removal of dimethyl disulfide using the present adsorbent media is enhanced as compared with using only the support material without the iron material, and is also enhanced as compared with using only the iron material.

The adsorbent media composition generally comprises a support material and a material that interacts with the target malodorous compound (also referred to herein as “removal material”) so as to bind or otherwise hold the malodorous compound. As such, the malodorous compound is removed from the gas. In particular, the adsorbent media composition is designed for removal of dimethyl disulfide and, as such, the composition comprises a support material and a material that removes dimethyl disulfide from the gas. As further described herein, the target malodorous compound may be specifically described as dimethyl disulfide. However, it is to be understood that additional malodorous compounds can be removed from the gas.

The combination of the support material and the removal material can be provided in a variety of forms. According to some embodiments, the support material is surface-modified by the removal material. The support material may be provided with the removal material coating at least a portion of one or more surfaces of the support material. This can be accomplished, for example, by spraying a liquid solution containing the removal material onto the support material and subsequently drying or curing as needed, or by dipping the support material into a solution bath containing the removal material and subsequently drying or curing as needed. The support material may be provided with the removal material impregnated or embedded in the support material. The removal material may be chemically or otherwise physically bound to one or more surfaces of the support material. Further, the removal material can be dispersed within the support material. Any combination of these options is also possible. Preferably, prior to addition of the removal material, the support material may be oxidized so as to facilitate subsequent binding or attachment of the removal material. The specific manner in which the removal material and support material are combined is not particularly limited provided that a contaminated gas is capable of coming into contact with and interacting with the removal material so that the removal material adsorbs one or more target malodorous compounds.

The support material itself can be provided in a variety of shapes, forms and sizes, including, but not limited to, granules, powders, particles, pellets, cylinders, trochiodal shapes, flakes, beads, rings, irregular shapes, extruded structures, matrices, honeycomb structures, meshes, helixes and combinations thereof. Any of these shapes can be provided in a generally solid form or a partially or completely hollow form.

The material utilized as the support material can be any conventional material used in gas purification processes including, but not limited to, various forms of alumina, carbon, zeolites, silica, and mixtures thereof. The support material can be a passive support material, wherein it primarily or solely functions to support the removal material, or an active support material, wherein it is structured and/or fabricated of a material that provides for additional attraction/binding of and removal of one or more target malodorous compositions.

Preferably, the support materials are activated forms (also commonly referred to as “active”), such as activated alumina and activated carbon. These activated forms have small, low-volume pores that increase the surface area of the material.

According to an exemplary embodiment, the support material comprises activated carbon. Activated carbons are produced from a variety of sources including wood, coal, peat, coconut shells, and recycled tires. Activation of carbon produces internal pores and carbon surfaces that increase surface area, thus increasing adsorption sites in the material and enhancing adsorptive capacity. Activated carbon is commonly provided as 1-3 mm diameter beads, 2-4 mm diameter extruded pellets, powder, and granules. Powder activated carbon (PAC), generally comprises crushed or ground carbon particles having a size such that 95-100% of the particles pass through an 80-mesh sieve (0.177 mm) and smaller. Granular activated carbon (GAC) has a relatively larger particle size compared to powdered activated carbon. Any commercially available activated carbon can be used as the support material of the present invention. Further, such commercially available activated carbon materials could also be modified as desired for use in the present invention (e.g., by grinding down or crushing particles or pellets to provide different particle sizes and shapes than those commercially available).

According to another exemplary embodiment, the support material comprises activated alumina. Activated alumina is produced from hydrated alumina by dehydrating under controlled conditions. According to some embodiments, the activated alumina is gamma or eta alumina, which have particularly high surface areas. The activated alumina can include conventional internal structures such as macropores (>1000 Å), mesopores (30 to 1000 Å), and/or micropores (<30 Å). Such commercially available activated alumina materials could also be modified as desired for use in the present invention (e.g., by grinding down or crushing particles or pellets to provide different particle sizes and shapes than those commercially available).

According to various embodiments, a combination of activated carbon and activated alumina is used as a support material. This can be accomplished by providing a mixture of (a) activated carbon in a desired size, shape and form, including but not limited to, granules, powders, particles, pellets, cylinders, trochiodal shapes, flakes, beads, rings, irregular shapes, extruded structures, matrices, honeycomb structures, meshes, helixes and combinations thereof, with the removal material combined therewith (e.g., by coating, impregnating or embedding, chemically or otherwise physically binding, and dispersing, or a combination thereof), and (b) activated alumina in a desired size, shape and form, including but not limited to granules, powders, particles, pellets, cylinders, trochiodal shapes, flakes, beads, rings, irregular shapes, extruded structures, matrices, honeycomb structures, meshes, helixes and combinations thereof, with the removal material combined therewith (e.g., by coating, impregnating or embedding, chemically or otherwise physically binding, and dispersing, or a combination thereof). This can alternatively be accomplished by providing a mixture of activated carbon and activated alumina and forming the mixture into a desired size, shape and form, including but not limited to granules, powders, particles, pellets, cylinders, trochiodal shapes, flakes, beads, rings, irregular shapes, extruded structures, matrices, honeycomb structures, meshes, helixes and combinations thereof, with the removal material combined with the formed mixture of activated carbon and activated alumina (e.g., by coating, impregnating or embedding, chemically or otherwise physically binding, and dispersing, or a combination thereof). The removal material can alternatively be combined with the mixture of activated carbon either before the mixture has been formed into the desired size, shape or form (e.g., by adding the removal material to the mixture of activated carbon and activated alumina prior to formation into pellets).

According to embodiments of the invention, the removal material interacts directly with dimethyl disulfide. In some embodiments, the support material further interacts directly with dimethyl disulfide and/or other malodorous compounds to provide additional removal of the dimethyl disulfide and/or other malodorous compounds. Any combination of chemisorption, physisorption, and/or capillary condensation can occur so as to remove the dimethyl disulfide from the gas.

While not wishing to be bound by theory, it is believed that the present adsorbent media composition interacts with the feed gas such that chemisorption occurs between the removal material and dimethyl disulfide to thereby remove the dimethyl disulfide by means of adsorption. In particular, it is believed that the dimethyl disulfide is trapped within the adsorbent media through the removal material (and, in some cases depending on the support material, also through the support material) where an essentially irreversible interaction, such as a chemical reaction or strong chemisorption, takes place to bind the dimethyl disulfide to the removal material and, in some cases, to the support material.

The removal material is a material that interacts with dimethyl disulfide in a gas so as to hold, bind or otherwise physically and/or chemically adhere the dimethyl disulfide and remove the dimethyl disulfide from the gas by adsorption. Iron and iron compounds interact and react with sulfur compounds, and thus it is believed that the presence of iron allows for a stronger interaction with sulfur species, particularly dimethyl disulfide. As such, when iron is integrated with a high-surface area support in accordance with the present invention, the resulting materials are shown to possess a particular affinity for dimethyl disulfide. As such, the removal material is a material that contains an amount of iron sufficient to interact with, hold, bind or otherwise physically and/or chemically adhere the dimethyl disulfide.

Through the incorporation of the iron material, the adsorbent media compositions provided by the present invention have an enhanced capacity for the adsorption of dimethyl disulfide from a gas containing at least dimethyl disulfide as an impurity.

According to various embodiments, the removal material is added to the support material to form iron or an iron compound adhered or bound to one or more surface of the support and/or dispersed within the support. Iron is typically introduced with the support material through the reaction or adsorption of iron compounds, such as ferrous sulfate or ferric chloride. Preferably, iron is introduced with the support material in the form of aqueous solutions. Iron may also be introduced in the form of iron nanoparticles or microparticles.

According to some embodiments, after the particular form of iron or iron composition is added to the support material, the additional components (e.g., sulfate, chloride, etc.) are subsequently removed (at least in part) from the adsorbent material to provide an iron removal material that comprises at least about 5 wt % iron or iron compounds. This can generally be accomplished by simple washing with water to remove the additional components. However, it has been found that these additional components do not interfere with iron's adsorptive capacity for malodorous compounds and, thus, it is not necessary to remove the additional components.

Preferably, the iron material is added to the support so that the end product (i.e., the adsorbent media composition) contains about 50 wt % to about 99. 9 wt % support material and about 0.1 wt % to about 50 wt % iron material, based on total weight of the adsorbent media composition. One or more additives that are conventionally provided in adsorbent media may be further included in the present composition, including but not limited to, colorants, binders, and UV inhibitors.

The iron material is preferably added to the support so that the end product comprises a support material to which iron has been incorporated as a coating, iron has been adhered, bound and/or otherwise dispersed as adherent particles, or iron has been adhered, bound and/or otherwise dispersed as granules.

According to one exemplary embodiment, a support material comprising activated alumina is immersed in a solution of about of about 1% to about 60% FeCl₃ for an extended period of time to allow for binding of the FeCl₃ to the support material. The iron modified support material may be optionally rinsed with water to remove the chloride component. Subsequently, the iron modified support material can be dried at a heightened temperature to provide the adsorbent media composition.

According to another exemplary embodiment, a support material comprising activated alumina is sprayed with a solution of about of about 1% to about 60% FeCl₃ to completely wet the support material and to allow for binding of the FeCl₃ to the support material. The iron modified support material may be optionally rinsed with water to remove the chloride component. Subsequently, the iron modified support material can be dried at a heightened temperature to provide the adsorbent media composition.

According to another exemplary embodiment, a mixture of activated alumina and FeCl₃ is formed. Preferably, the mixture contains about 50 wt % to about 99.9 wt % of activated alumina and about 0.1 wt % to about 50 wt % of FeCl₃. Liquid may be added to the mixture and the mixture pressed or otherwise shaped into discrete bodies, followed by heating to cure the bodies. The bodies can be used as such or can alternatively be broken down by any conventional means to provide for smaller sized granules or particles comprising the support material with the impregnated iron material. If desired, the bodies can be washed with water, typically prior to curing, to remove the chloride component.

The size, shape and form of the adsorbent media composition (e.g., granules, powders, particles, pellets, cylinders, trochiodal shapes, flakes, beads, rings, irregular shapes, extruded structures, matrices, honeycomb structures, meshes, helixes and combinations thereof) generally will vary depending on the manner in which the gas is placed into contact with the adsorbent media to remove the malodorous compounds. Any conventional methods for removal of impurities from a gas can suitably be used in the present invention, including but not limited to, packed columns, plate columns, spray chambers, spray towers, cyclonic spray chambers, and combinations thereof. Thus, for example, when the adsorbent media is provided in a packed column, the adsorbent media is provided in a shape, form and size that allows for placement of the adsorbent media within the column in the desired packed configuration and so as to allow for the gas feed to be efficiently and effectively passed through the packed adsorbent media. In such a configuration, as the particle size of the support material becomes smaller, the access to the surface area and the rate of adsorption becomes better. However, this also causes a pressure drop due to the small-sized packed particles which results in less space between the packed particles through which the gas can flow. Thus, these factors need to be weighed to provide an adsorbent media size, shape and form that will effectively and efficiently adsorb the target materials from a gas feed without requiring excessive force to feed the gas through the adsorbent media.

According to various embodiments, the adsorbent media composition is used in a gas purification process by providing the adsorbent media composition in a reactor through which a gas feed is passed, the gas feed containing at least dimethyl disulfide as an impurity. For example, the invention can include an apparatus for use in purifying a gas feed by removal of one or more impurities, wherein the apparatus comprises a flow path for a gas feed containing dimethyl disulfide as an impurity, wherein the flow path has a feed direction, and an adsorbent for dimethyl disulfide is positioned within the flow path.

For example, according to various embodiments, the adsorbent media composition is loaded into a reaction chamber or column directly (e.g. packing the chamber or column with the adsorbent media), or may be loaded into a reaction chamber or column that contains one or more filter beds which contain a layer of the adsorbent media packed therein. The gas is then fed into the column at one end (e.g., through a bottom end for a vertical chamber or a side end for a horizontal chamber) so as to pass through the chamber and the adsorbent media disposed therein. As the gas feed passes through the adsorbent media, one or more malodorous compounds, at least including dimethyl disulfide, interact with the iron material on the support material such that the dimethyl disulfide (and, in some embodiments, one or more additional malodorous compounds) is held, bound or otherwise attached thereto and removed from the gas feed. The gas exiting the reaction chamber or column is, thus, at least partially depleted of dimethyl disulfide (and, in some embodiments, one or more additional malodorous compounds). According to various embodiments, one or more pumps or other mechanisms are provided so as to provide an adequate force by which the gas is fed into and through the reactor.

According to various embodiments, the reactor is in the form of a compound-size bed, in which two different particle sizes of adsorbent media are arranged in series. Such an arrangement can be beneficial in achieving enhanced removal efficiency through the use of a plurality of different-sized adsorbent media. According to various other embodiments, the reactor is in the form of a compound-type bed, in which two or more types of adsorbent media compositions (e.g., having different components) are provided in series. Such an arrangement can be beneficial in achieving removal of multiple malodorous compounds through the use of a first adsorbent media that is provided to specifically target one or more first malodorous compounds (e.g. hydrogen sulfide), and a second adsorbent media that is provided to specifically target one or more different malodorous compounds (e.g. dimethyl disulfide).

The present adsorption process is beneficial because it can achieve removal of sulfur compounds at ambient pressures and temperatures. While the pressure and temperature at which the present method is carried out can be modified from ambient conditions (e.g., at heightened pressure and/or temperature), if desired, such modification is not necessary for effective removal of the target compounds.

It will be apparent to those skilled in the art that various modifications and variations can be made to the structure of the present invention without departing from the scope or spirit of the invention.

In view of the foregoing, it is intended that the present invention cover modifications and variations of this invention provided they fall within the scope of the following claims and their equivalents.

What is claimed is:

1. An adsorbent media composition for removing dimethyl disulfide from a gas containing at least dimethyl disulfide as an impurity comprising:
a support material selected from carbon, alumina, activated carbon, activated alumina, silica, zeolites and combinations thereof and
a removal material combined with the support material,
wherein the removal material is selected from materials that contain iron, and
wherein the removal material coats at least a surface of the support material, is impregnated or embedded in the support material, is physically or chemically bonded or adhered to at least one surface of the support material, is dispersed within the support material, or a combination thereof.

2. The adsorbent media composition of claim 1, wherein the adsorbent media composition comprises granules, powders, particles, pellets, cylinders, trochiodal shapes, flakes, beads, rings, irregular shapes, extruded structures, matrices, honeycomb structures, meshes, helixes and combinations thereof

3. The adsorbent media composition of claim 1, wherein the adsorbent media composition comprises about 50 wt % to about 99. 9 wt % support material and about 0.1 wt % to about 50 wt % of iron material, based on total weight of the adsorbent media composition.

4. An adsorbent media composition for removing dimethyl disulfide from a gas containing at least dimethyl disulfide as an impurity, the adsorbent media composition comprising:
a surface modified support material, wherein the support material is selected from carbon, alumina, activated carbon, activated alumina, silica, zeolites and combinations thereof, and wherein the support material is surface modified by a removal material comprising iron.

5. The adsorbent media composition of claim 4, comprising about 50 wt % to about 99. 9 wt % support material and about 0.1 wt % to about 50 wt % of iron material, based on total weight of the adsorbent media composition.

6. An apparatus for removal of dimethyl disulfide from a gas containing at least dimethyl disulfide as an impurity, the apparatus comprising:
a reactive chamber having an interior volume, an inlet and outlet, and a gas flow path within the interior volume extending between the inlet and outlet; and
an adsorbent media composition dispersed within the interior volume in the gas flow path, the adsorbent media composition comprising a support material and an iron based removal material.

7. The apparatus of claim 6, wherein the iron based removal material coats at least a surface of the support material, is impregnated or embedded in the support material, is physically or chemically bonded or adhered to at least one surface of the support material, is dispersed within the support material, or a combination thereof

8. The apparatus of claim 6, wherein the support material is surface modified by the iron based removal material.

9. The apparatus of claim 6, wherein the reactive chamber is in the form of a packed column, plate column, spray chamber, spray tower, or cyclonic spray chamber.

10. A method for removal of dimethyl disulfide from a gas containing at least dimethyl disulfide as an impurity, the method comprising:
providing an adsorbent media composition comprising a support material and an iron based removal material;
contacting the gas with the adsorbent media composition; and
allowing the adsorbent media composition to remove at least a portion of dimethyl disulfide from the gas via adsorption.

11. The method of claim 10, wherein the step of contacting the gas with the adsorbent media composition comprises passing the gas through a reaction chamber containing the adsorbent media therein.

12. The method of claim 11, wherein the reaction chamber is in the form of a packed column, plate column, spray chamber, spray tower, or cyclonic spray chamber.
